(19) United States
(12) Patent Application Publication
(10) Pub. No.: US 2002/0178129 A1
(43) Pub. Date: Nov. 28, 2002

(54) Lease-business support apparatus, lease-business support method, recording medium containing program for operating the lease-business support apparatus, and recording medium containing program for executing the lease-business support method

(76) Inventors: Katsunori Horimoto, Osaka (JP); Kunihiro Takeda, Kanagawa (JP); Hitomi Nemoto, Kanagawa (JP); Mitsuyoshi Uchida, Kanagawa (JP); Osamu Kawabata, Tokyo (JP); Toru Endo, Kanagawa (JP); Yoshihisa Tsuji, Kanagawa (JP); Shuji Shimada, Kanagawa (JP); Masayuki Enari, Kanagawa (JP); Hironori Kato, Chiba (JP); Yoko Toyoda, Kanagawa (JP); Hisahito Gondo, Kanagawa (JP); Hisayoshi Nakagome, Ibaraki (JP); Aritomo Sakamoto, Kanagawa (JP); Hideyasu Kokubo, Chiba (JP); Toshiaki Nagai, Tokyo (JP); Kiyotaka Iwamoto, Kanagawa (JP); Kazuo Hotta, Tokyo (JP); Yutaka Okazaki, Kanagawa (JP); Hisao Myoga, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/059,772

(22) Filed: Jan. 29, 2002

(30) Foreign Application Priority Data
Jan. 30, 2001 (JP) 2001-021409

(51) Int. Cl. G06F 17/00

(52) U.S. Cl. 705/400

(57) ABSTRACT

A lease-business support apparatus collects latest information from a brand-new-sales-company terminal, a secondhand-sales-company terminal, a leasing-company terminal, and a maintenance-company terminal which are related to lease business. By performing quality management and appropriate fixed-period-sales-price calculation based on the latest information, the lease-business support apparatus provides each customer terminal with appropriate lease-business information. This makes it possible to inexpensively lease a high-quality item.

### BACKGROUND OF THE INVENTION

1. Field of the Invention

The present invention relates to lease-business support apparatuses, lease-business support methods, recording media containing programs for operating the lease-business support apparatuses, and recording media containing programs for executing the lease-business support methods. In particular, the present invention relates to a lease-business support apparatus and method in which, by collecting latest information from companies related to lease businesses, that is, brand-new sales companies, secondhand sales companies, leasing companies, and maintenance companies, and using the latest information to perform quality management and a calculation of an appropriate fixed-period sales price for each item, high quality items can be inexpensively leased to customers. The present invention also relates to a recording medium containing a program for operating the lease-business support apparatus and a recording medium containing a program for executing the lease-business support method.

2. Description of the Related Art

Models in which a customer uses an apparatus or equipment include purchase, finance lease, operating lease, and rental. Although business-oriented apparatuses (excluding automobiles) are expensive, they become obsolete due to recent progress in technology before their lives end, and in fact may not be useful. Accordingly, in many cases, purchase of the apparatuses are carefully considered.

There is a lease contract form in which an apparatus can be used without being purchased. For example, a finance lease has a problem as to an apparatus having a short life cycle similarly to the case of purchasing the apparatus because the finance lease has a lease period of several years.

There is a rental contract form that enables the use of an apparatus for a short period. The rental fee per unit time is extremely higher compared with purchase or the finance lease.

In this respect, an operating lease is suitable for an expensive business-oriented item having a short life cycle because the operating lease is a contract form that can solve the above two problems. In recent circumstances in which progress is greatly made in technology, particularly in the introduction of industrial equipment, an operating lease, especially an operating lease having an intermediate lease period (meaning a lease period of approximately one to three years) has been in great demand.

Essential conditions for establishing the operating lease, especially for the intermediate-period operating lease are that there is a reliable secondhand market exists in which secondhand apparatuses can be constantly distributed and that sales companies (a brand-new sales company and a secondhand sales company) and a leasing company cooperate in doing business. However, presently, the reliable market has not been formed yet and there is no cooperation in business between the sales companies and the leasing company. Accordingly, the operating lease cannot be used by many customers.

### SUMMARY OF THE INVENTION

It is an object of the present invention to provide an inexpensive operating lease to a customer of high quality goods in such a way that, as to each product in which maintenance information retained in a maintenance company can be managed during the life of the product, by sharing the maintenance information, product information (such as a price, functions, and specifications), and market information in a database, quality management and an appropriate-price calculation for each product are performed. The present invention is suitable for the intermediate-period operating lease and can be also applied to other types of leases such as an operating lease having a lease period of five or six years, finance leases, and rentals.

To this end, according to an aspect of the present invention, the foregoing object is achieved through provision of a lease-business support apparatus in which lease-business-information-generating data is stored. The lease-business-information-generating data is used to generate the fixed-period sales price of an item, and lease-business information including the fixed-period sales price is provided to at least one customer terminal connected to the lease-business support apparatus in response to a request from the at least one customer terminal.

Preferably, the lease-business support apparatus further includes a fixed-period-sales-price generator for generating the fixed-period-sales price. The fixed-period-sales-price generator includes: a sales-price/purchase-price-data generator which generates the sales price and purchase price of the item by using an estimated sales price, a depreciation factor, legal durable years, and effective durable years which are included in the lease-business-information-generating data; and a fixed-period-sales-price calculator which receives and uses the sales price and the purchase price to generate the fixed-period-sales price.

The fixed-period-sales-price generator may include a price-adequacy checker which receives the fixed-period sales price from the fixed-period-sales-price calculator. The price-adequacy checker may calculate both a first gross profit obtained when simply selling an item and a second gross profit obtained by the fixed-period sale of the item, and verifies whether or not the second gross profit is greater than the first gross profit. The price-adequacy checker may calculate both the sum of a profit obtained by the fixed-period sale of identical models of the item and a profit obtained by the number of sales increased by the fixed-period sale, and the discarding cost required for discarding models among the identical models, and verifies whether or not the calculated sum is greater than the discarding cost. The price-adequacy checker may confirm price adequacy when the second gross profit is greater than the first gross profit and the calculated sum is greater than the discarding cost.

The “fixed-period sale” is defined as a lease contract implemented by the present invention, and the “fixed-period-sales price” is defined as a value obtained by the fixed-period sale and corresponds to a so-called “lease charge”.

The lease-business support apparatus may further include an item-information table containing lease periods as particulars which are correlated with the pieces of item-identification information. The lease-business support apparatus may provide the at least one customer terminal with lease-business information including a list of possible items to be leased.

The lease-business support apparatus may further include an item-information table containing lease periods as particulars which are correlated with the pieces of item-identification information. By using the lease periods, the lease-business support apparatus may provide the at least one customer terminal with information on each customer who is expected to desire a lease contract for an item after the lease period of the item terminates.

The customers may be classified into a plurality of classes based on at least one of business-record information and credit information corresponding to each of the customers, and a different type of lease-business information may be provided to each of the customer terminals corresponding to each of the customers in accordance with each of the classes to which the customer belongs.

The lease-business support apparatus may further include a layer identifying unit which acquires the class code corresponding to a customer ID sent from the customer terminal, a service-detail determination unit which receives the sent class code and acquires the service detail corresponding to the class code, and a service-detail generating unit which generates and provides, to the customer terminal, lease-business information based on the acquired service detail.

According to another aspect of the present invention, the foregoing object is achieved through provision of a lease-business support method for providing at least one customer terminal with lease-business information including the fixed-period sale of an item in response to a request from the at least one customer terminal. The lease-business support method includes the steps of: generating the sales price and purchase price of the item by using an estimated sales price, a depreciation factor, legal durable years, and effective durable years; and generating the fixed-period-sales price of the item by receiving and using the generated sales price and purchase price.

Preferably, the lease-business support method further includes the steps of: calculating both a first gross profit obtained when simply selling the item and a second gross profit obtained by the fixed-period sale of the item and verifying whether or not the second gross profit is greater than the first gross profit; calculating both a profit obtained by the fixed-period sale of identical models of the item and the discarding cost required for discarding models among the identical models and verifying whether or not the profit is greater than the calculated discarding cost; and confirming price adequacy when the second gross profit is greater than the first gross profit and the profit is greater than the calculated discarding cost.

According to a further aspect of the present invention, a computer-readable recording medium is provided which contains a program for operating the lease-business support apparatus.

According to a further aspect of the present invention, a computer-readable recording medium is provided which contains a program for controlling a computer to execute the lease-business support method.

According to the present invention, an advantage is obtained in that a high-quality item can be inexpensively leased to each customer by performing both management of maintenance information and an appropriate calculation of a fixed-period sales price for each item.

### BRIEF DESCRIPTION OF THE DRAWINGS

FIG. 1 is a block diagram showing a lease-business support apparatus according to a first embodiment of the present invention and apparatuses connected to the lease-business support apparatus;

FIG. 2 is a block diagram showing the lease-business support apparatus according to the first embodiment;

FIG. 3 is a block diagram showing a fixed-period-sales-price generator in the lease-business support apparatus shown in FIG. 2;

FIG. 4 is a flowchart showing the operation of the fixed-period-sales-price generator shown in FIG. 3;

FIG. 5 is a graph showing calculated sales price and purchase price;

FIG. 6 is a block diagram showing the lease-business-information-generating-data manager shown in FIG. 3;

FIG. 7 is an illustration of each record in the item-information table shown in FIG. 3;

FIG. 8 is an illustration of each record in the customer-information table shown in FIG. 3;

FIG. 9 is an illustration of each record in the fixed-period-sales-price table shown in FIG. 3;

FIG. 10 is an illustration of each record in the assessed-price table shown in FIG. 3;

FIG. 11 is an illustration of each record in the cost table shown in FIG. 3;

FIG. 12 is a block diagram showing a lease-business-information provider 22 in a lease-business support apparatus according to a second embodiment of the present invention;

FIG. 13 is a flowchart showing a process performed by the lease-business support apparatus according to the second embodiment when it receives an item-retrieval request sent from a customer terminal;

FIG. 14 is a block diagram showing a lease-business-information provider 22 in the lease-business support apparatus according to the second embodiment;

FIG. 15 is an illustration of the structure of the service-detail table shown in FIG. 14;

FIG. 16 is an illustration of a lease-business model to which an embodiment of the present invention is applied; and

FIG. 17 is an illustration of a lease-business model to which an embodiment of the present invention is applied.

### DESCRIPTION OF THE PREFERRED EMBODIMENTS

Before embodiments of the present invention are described, an operating lease (hereinafter referred to as “fixed-period sale”) treated in the present invention is described below.

In general, the “value” of a product can be divided into two types. One is a value from one-dimensional evaluation based on the amount of money obtained when the product is purchased or sold, and the other one is a value from two-dimensional evaluation based on the integration of a “utility value” produced by the product and “duration of use” of the product. It may be said that the latter is more accurate from the point of view of economic effects. In actual economic scenes, there are no small number of cases in which a great difference is found between the former and the latter.

In a fixed-period sale according to the present invention, by paying attention to the above difference, and by selling in a fixed period to different customers, a new profit structure can be established.

Regarding a product in which, among product information (including functions and specifications), market information, and maintenance information which are used as keys for determining the value of a product, the maintenance information can be managed during the life of the product, a scheme is developed which deduces a precise sales price and a precise purchase price by integrating the above pieces of information, and identical products are sold together with maintenance to customers in fixed-period sale performed in a period which is longer than that of a rental and is shorter than that of a finance lease. This enables obtainment of a profit that is greater than that obtained by outright sale, the finance lease, or the rental. Also, by always retaining property, the life on the market of each product can be controlled, thus enabling an increased number of sales and more strategic marketing.

### Fixed-Period-Sale Model

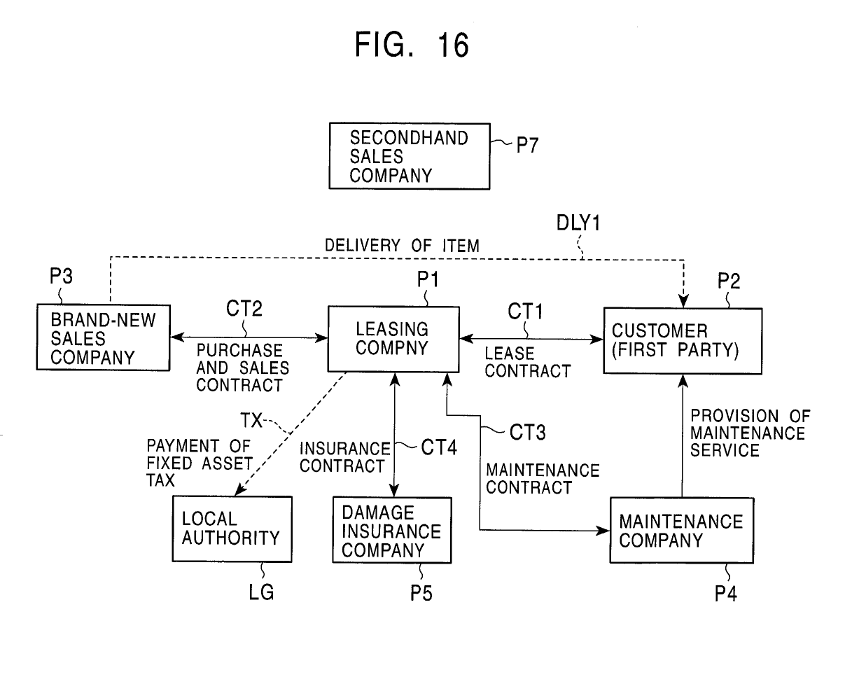

A lease business model which can be provided by an embodiment of the present invention is described below with reference to FIG. 16.

FIG. 16 illustrates the lease business model. The lease business model includes a lease contract CT1 between a leasing company P1 (lessor) and a customer (first party) P2, a business contract CT2 between the leasing company P1 and a brand-new sales company P3, a maintenance contract CT3 between the leasing company P1 and a maintenance company P4, and an insurance contract CT4 between the leasing company P1 and a damage insurance company P5.

First, the customer (first party) P2 selectively determines a desired item, and makes an agreement with the brand-new sales company P3 on the price of the item, a date of delivery, a place of delivery, etc.

Second, when desiring to use the item on a lease, the customer (first party) P2 applies to the leasing company P1 for a lease. When determining to accept the application for the lease, the leasing company P1 (lessor) concludes the lease contract CT1 with the customer (first party) P2 (lessee) after confirming the conditions of the lease contract CT1.

Third, based on the concluded lease contract CT1, the leasing company P1 immediately concludes the business contract CT2 for the item desired by the customer (first party) P2 with the brand-new sales company P3.

Fourth, based on the concluded business contract CT2, the brand-new sales company P3 directly delivers the item to the place of delivery designated by the customer (first party) P2 (delivery of the item DLY1 shown in FIG. 16). The lease to the customer (first party) P2 of the item starts on a lease date written on a receipt of lease which is issued from the customer (first party) P2 to the leasing company P1. From the lease date, the customer (first party) P2 may use the item and is responsible for payment of a lease charge to the leasing company P1.

Based on the business contract CT2, the item is regarded as having been delivered from the brand-new sales company P3 to the leasing company P1. The leasing company P1 pays the price of the item to the brand-new sales company P3.

According to the lease contract CT1, in general, the leasing company P1 is obliged to maintain and repair the item. The leasing company P1 concludes the maintenance contract CT3 with the maintenance company P4. Based on the maintenance contract CT3, a maintenance service is directly offered from the maintenance company P4 to the customer (first party) P2.

In addition to the above contracts, the leasing company P1 notifies the damage insurance company P5 of the lease simultaneously with the start of the lease and makes the insurance contract CT4 since it is common in a lease contract for an item to be insured. The leasing company P1 accordingly pays an insurance fee to the damage insurance company P5, and performs the filing and payment to a local government LG of a fixed asset tax imposed on the item during the lease period.

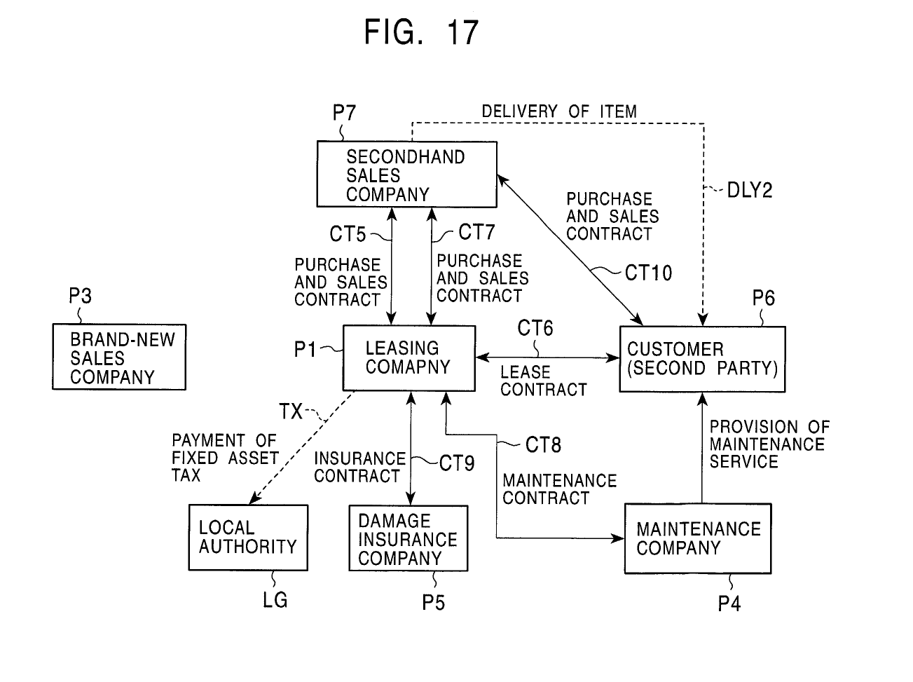

FIG. 17 illustrates a lease business model in a case in which, after the lease contract CT1 between the leasing company P1 and the customer (first party) P2 expires or is cancelled before expiration, the item is leased to another customer (second party) P6.

First, after the lease contract CT1 expires, a secondhand sales company P7 purchases (business contract CT5 ) the item from the leasing company P1. The secondhand sales company P7 exhibits the item to the customer (second party) P6. When the customer (second party) P6 trades in his or her own secondhand item, a business contract CT10 is made between the secondhand sales company P7 and the customer (second party) P6.

The customer (second party) P6 selectively determines a desired item, and agrees with the secondhand sales company P7 on the price of the item, a date of delivery, and a place of delivery.

When the customer (second party) P6 desires to use the item on a lease, it applies to the leasing company P1 for a lease of the item. When determining to accept the application of the lease, the leasing company P1 (lessor) concludes a lease contract CT6 with the customer (second party) P6 (lessee) after confirming the conditions of the lease contract CT6.

Next, based on the lease contract CT6, the leasing company P1 concludes a business contract CT7 for the item desired by the customer (second party) P6 with the secondhand sales company P7.

Based on the business contract CT7, the secondhand sales company P7 directly delivers the item to a place of delivery designated by the customer (second party) P6 (delivery of item “DLY” shown in FIG. 17). The lease to the customer (second party) P6 of the item starts on a lease date written on a receipt of lease which is issued from the customer (second party) P6 to the leasing company P1. From the lease date, the customer (second party) P6 may use the item and is responsible for payment of a lease charge to the leasing company P1.

Based on the business contract CT7, the item is regarded as having been delivered on the lease date from the secondhand sales company P7 to the leasing company P1. The leasing company P1 pays the price of the item to the secondhand sales company P7.

According to the lease contract CT6, in general, the leasing company P1 is obliged to maintain and repair the item. The leasing company P1 concludes a maintenance contract CT8 with the maintenance company P4. Based on the maintenance contract CT8, a maintenance service is directly offered from the maintenance company P4 to the customer (second party) P6.

In addition to the above contracts, the leasing company P1 notifies the damage insurance company P5 of the lease simultaneously with the start of the lease and makes an insurance contract CT9 since it is common in a lease contract for an item to be insured. The leasing company P1 accordingly pays an insurance fee to the damage insurance company P5 and performs the filing and payment to the local government LG of a fixed asset tax imposed on the item during the lease period.

After the lease to the customer (second party) P6 expires, the item can be leased to another customer (third party) (not shown). In this case, similar contracts are made, such as a lease contract between the leasing company P1 and the customer (third party), a business contract between the leasing company P1 and the secondhand sales company P7, a maintenance contract between the leasing company P1 and the maintenance company P4, and an insurance contract between the leasing company P1 and the damage insurance company P5.

### Merits for Secondhand Sales Company P7

Merits for the secondhand sales company P7 in the above forms of lease business are described below.

The sale of a lease contract on a new product is achieved such that, when the lease contract expires, the secondhand sales company P7 engages to purchase the product at a set price. It is common for the set price to be cheaper than the market price because the leasing company P1 is incapable of selling a lease-expired item having a remaining value. Accordingly, the secondhand sales company P7 can purchase a lease-expired item on a predetermined occasion at a price cheaper than the market price.

A sales price, a purchase price, and a fixed-period sales price which are riskless and reliable can be set such that the brand-new sales company P3 provides product information (price, function, specifications, etc.), information about falling prices of similar products, effective durable years, a plan of future goods, and other information such as market information, and the maintenance company P4 provides maintenance-cost information and a maintenance record.

The secondhand sales company P7 consistently undertakes maintenance, whereby the use of management irrespective of a change of owner or user ensures quality maintenance. Although the leasing company P1 may perform maintenance, this model uses the maintenance company P4 to perform maintenance and uses a database to perform management. Accordingly, this generates a competitive advantage over other secondhand sales companies that do no have the above function.

In the lease business, a risk that each item may be left in idle stock is reduced because the period of the lease is longer than the period of rental, and the lease business can be operated with a small sales cost because the number of item turnover is small. In addition, it is possible for the lease business to set a price to be much cheaper than that set when a rental company rents an item for a long period, so that large profitability can be expected.

By using the leasing company P1 for a lease, the leasing company P1 is controlled to perform a function of verifying customer credit, thus enabling business in which a financial risk such as a bad debt is reduced.

In order to achieve the rapid switching of the market to the next model, by using a sale company to control a turnover of products, the number of sales can be increased and more strategic marketing can be developed.

The present invention can be a pioneering model used when a recycle culture will be developed in future.

### Merits for the Leasing Company P1

The secondhand sales company P7 is obliged to perform purchase at the remaining value, whereby a lease having a commercial value can be implemented and the amount of business increases.

### Merits for the Brand-new Sales Company P3

By implementing a lease of attractive goods, the amount of sales increases.

By using the secondhand sales company P7 to perform purchase from the secondhand market, the number of secondhand items can be controlled and sales opportunity can be increased.

By using a switchover program for switching among a plurality of apparatuses, a rapid switchover can be performed which minimizes a temporary drop in sales.

### 1. First Embodiment of the Present Invention

A first embodiment of the present invention is described below with reference to the accompanying drawings.

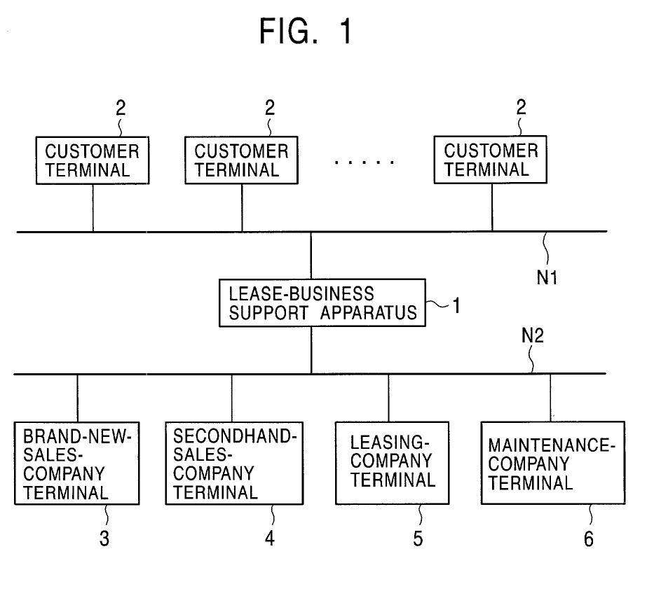

FIG. 1 is a block diagram showing a lease-business support apparatus 1 according to the embodiment and apparatuses connected thereto. The lease-business support apparatus 1 means an apparatus that provides information (hereinafter referred to as “lease-business information”) on lease business for the purpose of supporting those who are related to the lease business.

A lease-business support apparatus 1 is connected to customer terminals 2 by a communication network N1 and is connected by a communication network N2 to a brand-new-sales-company terminal 3, a secondhand-sales-company terminal 4, a leasing-company terminal 5, and a maintenance-company terminal 6.

### 1.1. Communication networks N1 and N2

Each of the communication networks N1 and N2 operates so that, when an apparatus connected to the communication network establishes a session with respect to a desired apparatus by wire or by radio, information can be transmitted and received between both apparatuses. Accordingly, each of the communication networks N1 and N2 may be formed by combining a plurality of networks using gateways as in the Internet although FIG. 1 shows that each apparatus is connected to a single base line as the communication network. In addition, even if the communication network is used to temporarily connect one apparatus to another apparatus by PPP connection, without using direct connection to a so-called backbone, the communication network may be designed so that information can be transmitted and received between both apparatuses when a session is established.

The communication networks N1 and N2 may not be separate. A single communication network may be used as both communication networks N1 and N2. In order that lease-business information may be prevented from leaking on a possible level, the communication network N2 may be a dedicated network to which only the brand-new-sales-company terminal 3, the secondhand-sales-company terminal 4, the leasing-company terminal 5, and the maintenance-company terminal 6 can be connected.

### 1.2 Customer Terminal 2

Each customer terminal 2 is an information processing apparatus which is connected to the communication network N1 and which can request the lease-business support apparatus 1 to provide lease-business information and can receive the provided lease-business information. The customer terminal 2 is, for example, a personal computer, a workstation, or a portable terminal. Regarding the connection form, the customer terminal 2 may be linearly connected by wire or may be linked by radio. For example, it is preferable for the customer terminal 2 to include an information transmitting unit that can transmit a message of requesting lease-business information to the lease-business support apparatus 1 in such a way that a user performs a predetermined operation by using input devices such as a keyboard and a pointing device, and an information viewing unit that can receive lease-business information having a Web-document form and can provide the information in a form which enables the user to visually or audio visually recognize the information. For example, when the information processing apparatus uses the “Windows” (registered trademark) made by Microsoft Corporation as an operating system, so-called “browser software” such as the “Internet Explorer” (registered trademark) made by Microsoft Corporation and the “Netscape Communicator” (registered trademark) made by Netscape Communications, Inc. can be used as the information viewing unit and the information transmitting unit.

### 1.3. Brand-New-Sales-Company Terminal 3, Secondhand-Sales-Company Terminal 4, Leasing-Company Terminal 5, and the Maintenance-Company Terminal 6

Each of the brand-new-sales-company terminal 3, the secondhand-sales-company terminal 4, the leasing-company terminal 5, and the maintenance-company terminal 6 (these terminals are hereinafter generically referred to as “related-company terminals”) is an information processing apparatus which is connected to the communication network N2 and which can provide the lease-business support apparatus 1 with data (hereinafter referred to as “lease-business-information-generating data”) for generating lease-business information and can receive the provided lease-business information. The brand-new-sales-company terminal 3, the secondhand-sales-company terminal 4, the leasing-company terminal 5, and the maintenance-company terminal 6 are, for example, personal computers, workstations, or terminal units.

Each related-company terminal preferably includes an information transmitting unit that can transmit lease-business-information-generating data to the lease-business support apparatus 1 in such a way that a user performs a predetermined operation by using input devices such as a keyboard and a pointing device, and an information viewing unit that can receive lease-business information having a Web-document form and can provide the information in a form which enables the user to visually or audio visually recognize the information. For example, when the information processing apparatus uses the “Windows” (registered trademark) made by Microsoft Corporation as an operating system, so-called “browser software” such as the “Internet Explorer” (registered trademark) made by Microsoft Corporation and the “Netscape Communicator” (registered trademark) made by Netscape Communications, Inc. can be used as the information viewing unit and the information transmitting unit.

### 1.4. Lease-Business Support Apparatus 1

The lease-business support apparatus 1 is, for example, an information processing apparatus (such as a computer) which is connected to the communication networks N1 and N2 and which can transmit/receive information to/from each customer terminal 2 and each related-company terminal. Specifically, when the customer terminal 2 requests the lease-business support apparatus 1 to provide lease-business information, the lease-business support apparatus 1 transmits necessary information in response to the request. When receiving lease-business-information-generating data from the relate(d-company terminal, the lease-business support apparatus 1 stores the data, and based on the stored data, the lease-business support apparatus 1 generates and stores fixed-sale-price data. The lease-business support apparatus 1 may be designed so as to transmit/receive information to/from the customer terminal 2 and the related-company terminal. Regarding the connection between the lease-business support apparatus 1 and each terminal, the lease-business support apparatus 1 may be linearly connected by wire or may be linked by radio.

### 1.4.1. Example of Structure of Lease-Business Support Apparatus 1

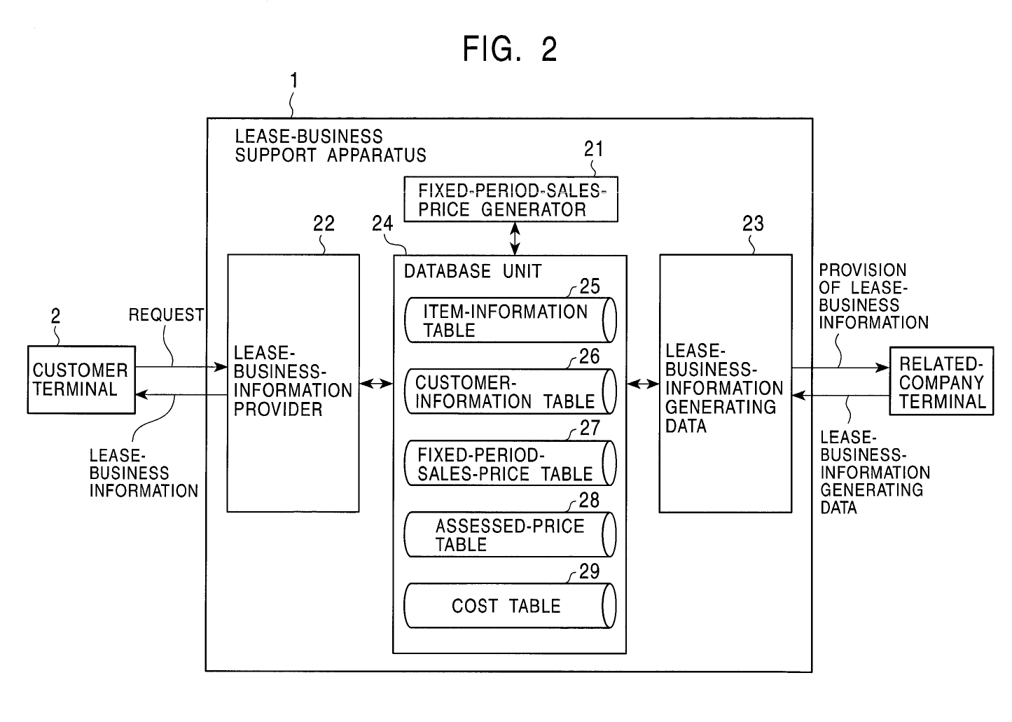

FIG. 2 is a block diagram showing an example of the structure of the lease-business support apparatus 1 according to the embodiment. As shown in FIG. 2, the lease-business support apparatus 1 includes a database unit 24 in which lease-business-information-generating data is stored in a readable and writable form, a fixed-period-sales-price generator 21 for generating fixed-period-sales-price data based on the lease-business-information-generating data, a lease-business-information provider 22 which receives a lease-business-information request from the customer terminal 2 and which extracts, from the database unit 24, lease-business information matching the request and transmits the extracted information to the customer terminal 2, and a lease-business-information-generating-data manager 23 which writes, in the database unit 24, lease-business-information-generating data received from the related-company terminal and which extracts lease-business information from the database unit 24 in response to a request received from the related-company terminal and transmits the extracted information to the related-company terminal having sent the request.

The database unit 24 includes an item-information table 25 on which information on items to be leased is recorded in a form correlated with each item identifier (ID), a customer-information table 26 on which information on each customer is recorded in a form correlated to each customer identifier (ID), a fixed-period-sales-price table 27 on which the fixed-period-sales-price data generated by the fixed-period-sales-price generator 21 is recorded in a form correlated with each item ID, and an assessed-price table 28 on which information for calculating the assessed price of each item is recorded, and a cost table 29 on which lease-business-related costs (e.g., an insurance fee, a fixed asset tax, etc.) are recorded.

### 1.4.1.1. Example of Structure of Fixed-Period-Sales-Price Generator 21

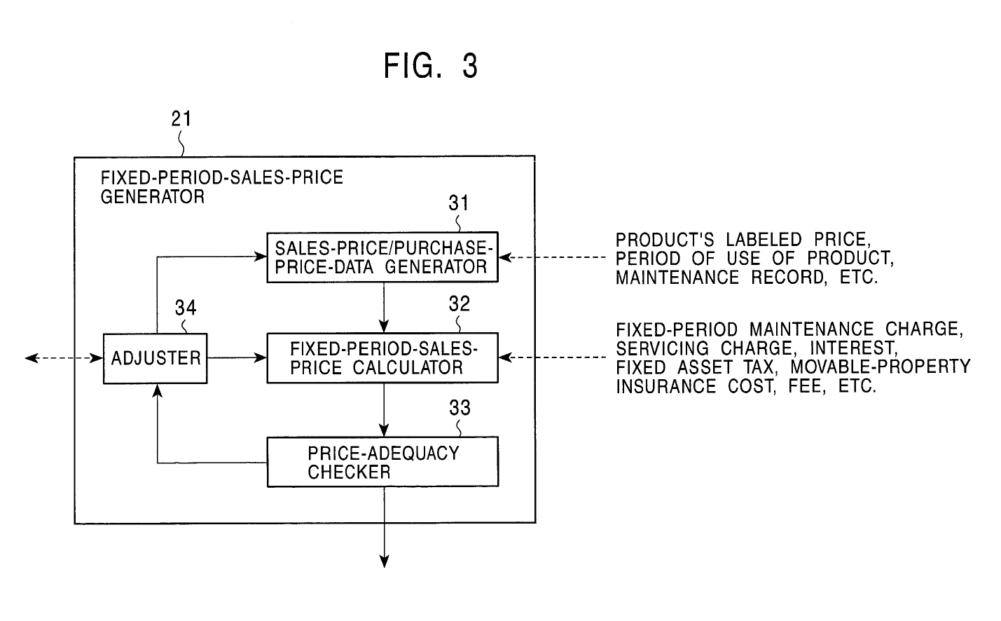

FIG. 3 is a block diagram showing an example of the structure of the fixed-period-sales-price generator 21 in the embodiment. As shown in FIG. 3, the fixed-period-sales-price generator 21 includes a sales-price/purchase-price-data generator 31 that, by acquiring data such as “estimate of product price at the time X years have passed” and “effective durable years” which are correlated with each item ID or model name, generates the sales price and purchase price after X years of the item or model, a fixed-period-sales-price calculator 32 that calculates the fixed-sales price of the item or model based on the sales price and purchase price received from the sales-price/purchase-price-data generator 31, a price-adequacy checker 33 which, based on the sales price and purchase price after X years and the fixed-sales price which are received, verifies adequacy for the sales price and purchase price, and in which when the adequacy is verified, the checker 33 records the sales price, the purchase price, and the fixed-sales price in correlation with the corresponding item ID or model name, and when the adequacy is not verified, the checker 33 sends a request to correct the sales price, the purchase price, and the fixed-sales price, and an adjuster 34 that automatically or manually adjusts the data for generating the sales price, the purchase price, and the fixed-sales price when receiving the request.

### 1.4.1.2. Operation Example of Fixed-Period-Sales-Price Generator 21

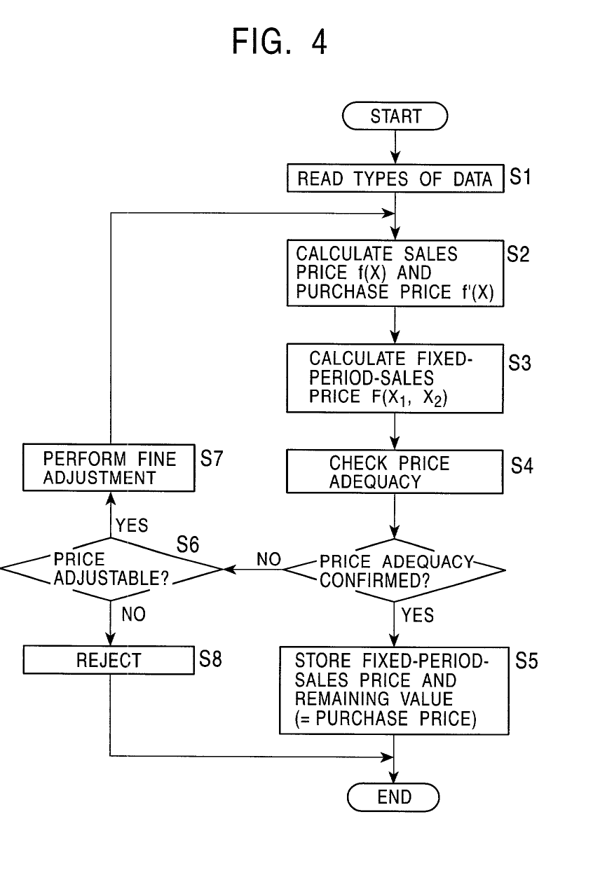

The operation of the fixed-period-sales-price generator 21 is described below with reference to FIG. 4.

FIG. 4 is a flowchart showing the operation the fixed-period-sales-price generator 21.

In step S1, the fixed-period-sales-price generator 21 reads the data required for generating the fixed-period-sales price, etc, from the database unit 24. Specifically, the sales-price/purchase-price-data generator 31 acquires the data such as the estimate of product price after X years and the effective durable years from the assessed-price table 28. From the assessed-price table 28, data such as “fixed-period maintenance charge”, “servicing charge”, “interest”, “fixed asset tax”, “movable-property-insurance cost”, and “fee” is acquired and temporarily stored by the fixed-period-sales-price calculator 32.

In step S2, the sales price and the purchase price are calculated. The calculation is performed in the following method. The sales price is represented by f(x), where X represents the number of years which have passed since the production of the item. The expression f(x) is determined by the following expression:

f(X)=s(X)×T^{X·Y/L}+e(X) (1)

where s(X) represents an estimated price after X years of a product identical to the item, T represents a depreciation factor, Y represents the number of years which is a legal utility life of the item, L represents durable years of the item, and e(X) represents another external factor which is, for example, a price drop due to the emergence of a new model of identical product. In general, the legal life of an electronic device such as a professional-quality video camera is six years (Y=6), and in this case, 0.681 (T =0.681) is used as a depreciation factor.

When the sales price is represented by f′(X), f′(X) is determined by the following expression:

f′(X)=kf(X) (2)

where k represents a profit coefficient for determining a profit, for example, 0.8 is used as K. This profit coefficient may be one of variables to be adjusted by the above adjuster 34.

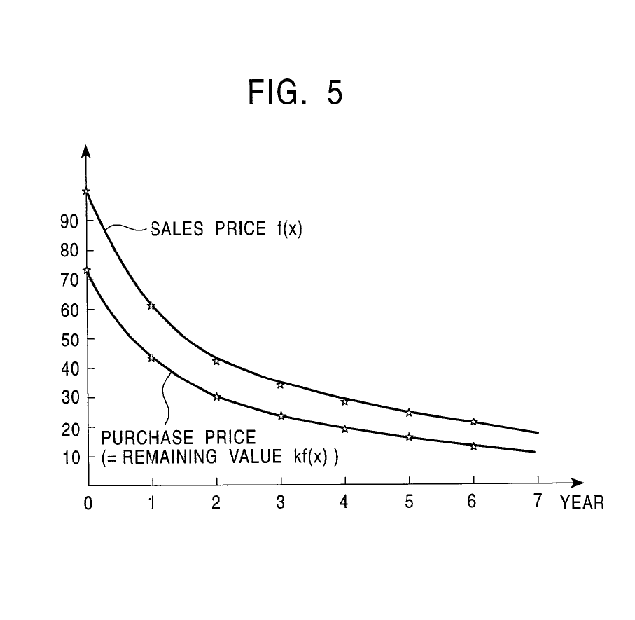

By using the expressions (1) and (2), all the sales prices and purchase prices obtained when 0≦X≦Y are calculated. FIG. 5 is a graph showing the calculated sales prices and purchase prices.

Referring back to FIG. 4, in step S3, the fixed-period sales price is calculated after the sales prices and purchase prices are calculated. The fixed-period sales price is represented by F(X₁, X₂), where X₁ represents the number of years from the production of the item to the start of the period (lease period) of the fixed-period sale, and X₂ represents the number of years from the production of the item to the end of the lease period. For example, when an item that has been used for one year is leased for two years, X₁=1, and X₂=3. F(X₁, X₂) is determined by the following expression:

$$\begin{matrix}F ( {X}_{1} , {X}_{2} ) = ( f ( {X}_{1} ) - {f}^{′} ( {X}_{2} ) ) + m ( {X}_{1} , {X}_{2} ) + h ( {X}_{1} , {X}_{2} ) + \\ r ( {X}_{1} , {X}_{2} ) + p ( {X}_{1} , {X}_{2} ) + d ( {X}_{1} , {X}_{2} ) + q ( {X}_{1} , {X}_{2} )\end{matrix} \qquad ( 3 )$$

where m(X₁, X₂) represents the maintenance charge required for the lease period (the first year and the second year), h(X₁, X₂) represents the insurance fee required for the lease period, r(X₁, X₂) represents the servicing charge required for the lease period, p(X₁, X₂) represents the payment of the interest required for the lease period, and q(X₁, X₂) represents the leasing company fee required for the lease period. In other words, by adding the interest, the insurance fee, and the leasing company fee to a value obtained such that the purchase price (=the remaining price) in the second year is subtracted from the sales price of the item in the first year, the fixed-period sales price is calculated. The fixed-period-sales-price calculator 32 calculates the values of F(X₁, X₂) obtained for all the combinations of X₁ and X₂ which satisfy the condition that 0≦X₁≦Y and 0≦X₂≦Y and X₁<X₂ , whereby F(0, 1), F(0, 2), . . . and F(Y−1, Y) are generated.

In step S4, the price-adequacy checker 33 verifies whether or not the price calculated by using the generated f(x) and f′(x) is set to a value which can actually make a profit in the fixed-period sale. Price adequacy is verified by the following two techniques.

In one technique, the price-adequacy checker 33 verifies whether or not a gross profit P2 obtained by the fixed-period sale of the item is greater than a gross profit P1 obtained by simply selling a new product. This can prevent the setting of a fixed-period sales price that makes a profit which is less than that in the case of simply selling the new product. Specifically, the first verification is performed such that the price-adequacy checker 33 executes the following operations:

P1<P2 (4)

P1=f(X₀)−Cost Price of the Item (5)

$$\begin{matrix}P 2 = ( f ( {X}_{0} ) - Cost Price of the Item ) + \\ {K}_{12} ( f ( {X}_{1} ) - {f}^{′} ( {X}_{2} ) ) + {K}_{13} ( f ( {X}_{1} ) - {f}^{′} ( {X}_{3} ) ) + \\ {K}_{14} ( f ( {X}_{1} ) - {f}^{′} ( {X}_{4} ) ) + {K}_{15} ( f ( {X}_{1} ) - {f}^{′} ( {X}_{5} ) ) + … + \\ {K}_{1 N} ( f ( {X}_{1} ) - {f}^{′} ( {X}_{N} ) ) + {K}_{23} ( f ( {X}_{2} ) - {f}^{′} ( {X}_{3} ) ) + \\ {K}_{24} ( f ( {X}_{2} ) - {f}^{′} ( {X}_{4} ) ) + … + {K}_{2 N} ( f ( {X}_{2} ) - {f}^{′} ( {X}_{N} ) ) ⋯ + \\ {K}_{( N - 2 ) ( N - 1 )} ( f ( {X}_{N - 2} ) - {f}^{′} ( {X}_{N - 2} ) ) + {K}_{( N - 2 ) N} ( f ( {X}_{N - 2} ) - \\ {f}^{′} ( {X}_{N} ) ) + {K}_{( N - 1 ) N} ( f ( {X}_{N - 1} ) - {f}^{′} ( {X}_{N} ) ) - \\ Cost for Fixed \text{-} period Sale\end{matrix} \qquad ( 6 )$$

In the expression (6), N represents a year-unit lease period of N years, and K_{ab} represents a ratio of a period in which the item is leased from the time “a” years pass since the sale of the item as a new product to the time “b” years pass. The “Costs for Fixed-period Sale” means the costs (such as a material cost, a labor cost, charges, and a depreciation cost) required for preparation performed by purchasing a secondhand product in fixed-period sale in order that the product may be leased to the next customer.

Second verification is performed by determining whether or not the fixed-period sales price is set to a value which actually makes a profit as to the entirety of models to which the item belongs.

Regarding items to be sold by fixed-period sale, products of an identical model are well marketed. These products are treated as secondhand items after new products and new-product sales-promotion equipment are treated as items to be leased. In this case, the number of items that are marketed as the new products or new-product sales-promotion equipment is represented by N1, and the number of items among N1 items which are treated as items to be leased by those who purchase only secondhand items is represented by N2. Because N2 items make profit P2 per item which is calculated by expressions (4) to (6), the entirety of the identical items makes a profit that is N2 times the value “P2−P1”. In addition, when the number of sales which is likely to be increased by using the lease (fixed-period sale) is represented by α, a profit represented by α×P1 is also made. All. N1 items are not treated as items to be leased, and (N1−N2) items remain, so that a cost for discarding the remaining items is required. At this time, the profit for the entirety of the identical items by using the fixed-period sale must be greater than the discarding cost.

Specifically, it is determined whether or not the following expression holds:

(P1-P2)×N2+α×P1>(N1-N2)×Discarding Cost Per Item (7)

When the results of the first verification and the second verification are affirmative, the price adequacy is confirmed, and the calculated sales price, purchase price, and fixed-period sales price are sent from the price-adequacy checker 33 and are stored in the database unit 24 (step S5). When the result of at least one of the first verification and the second verification is negative, it is determined in step S6 whether or not the prices can be adjusted. Specifically, when being notified of inadequacy by the price-adequacy checker 33, the adjuster 34 performs a price fine-adjustment process. It is possible that the price fine-adjustment process be performed by various techniques. In one technique, the adjuster 34 automatically increases or reduces each constant or coefficient of each expression in a predetermined increment or decrement width. When the increased or reduced value is within a predetermined allowable range, the adjuster 34 may determine that the adjustment is possible. When the increased or reduced value is not within the allowable range, the adjuster 34 may determine that the adjustment is impossible. In another technique, the adjuster 34 may prompt the user to determine whether the adjustment is possible or impossible by using a terminal or the like of the lease-business support apparatus 1 to display a message of price inadequacy and numerical values (such as the profit factor k) which indicate the inadequacy. The adjuster 34 may be designed so that it can determine that the adjustment is possible when the user inputs a changed value, while it can determine that the adjustment is impossible when no value is input (e.g., a case in which a stop command is input). Definitely, it is possible that other adjustment techniques be used.

When the adjustment is possible, the fine-adjustment process is performed by replacing a constant, a coefficient, etc., in step S7. After that, by using the fine adjusted values, the sales price and the purchase price are calculated in step S2, the fixed-period sales price is calculated in step S3, and the price adequacy is verified in step S4.

When the adjustment is impossible, the calculated values such as the sales price are regarded as inappropriate, and are discarded in step S8, without being stored in the database unit 24.

By performing the above process shown in FIG. 4, only appropriate sales, purchase, and fixed-period-sales prices are stored in the lease-business support apparatus 1 according to the present invention. This makes it possible to provide appropriate lease-business information to all persons who use, the lease-business support apparatus 1.

Marketability may be checked together with the verification of the price adequacy. In many cases, in the information processing apparatus case, the prices of products having identical functions may greatly drop in a short period differently from automobile business. Accordingly, by collecting, as much as possible, from the brand-new sales company 3, the information required for knowing impressions on the fixed-period-sales price, that is, the market price of a brand-new product similar to the present product, the market price of a brand-new product in the future, the, details of the functions and performance of the above product, and a plan for the development of a type of product similar to the above product, and calculating a profit based on the estimation of an acceptable price and possible sales of the future at the acceptable price after performing human determination based on the collected information of the acceptable price, adequacy from a market aspect for the calculated sales price, purchase price, and fixed-period sales price may be considered.

### 1.4.2. Example of Structure of Lease-Business-Information-Generating-Data Manager 23

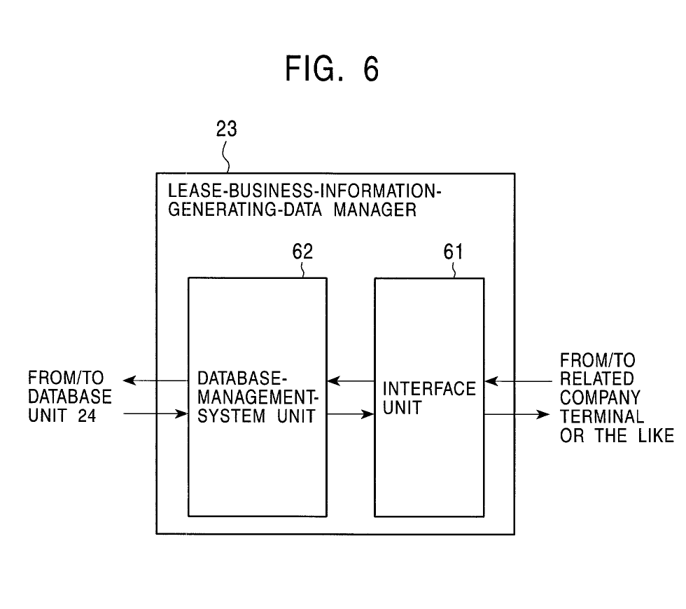

An example of the structure of the lease-business-information-generating-data manager 23 is described below with reference to FIG. 6.

FIG. 6 is a block diagram showing the lease-business-information-generating-data manager 23. The lease-business-information-generating-data manager 23 includes an interface unit 61 connected to the related-company terminal, and a database-management-system unit 62 which is connected to the interface unit 61 and which is connected the database unit 24.

The database-management-system unit 62 has functions of performing storage management, access control, query processing, and transaction processing on the database unit 24 in response to commands and data from the related-company terminal.

The interface unit 61 has functions of processing the commands and data from the related-company terminal to generate a form, processible for reception by the database-management-system unit 62, and processing the data extracted from the database unit 24 to generate a form (e.g., HTML document) receivable by the related-company terminal before transmitting the processed data.

### 1.4.3. Example of Structure of Database Unit 24

An example of the structure of the database unit 24 is described below.

As shown in FIG. 2, the database unit 24 includes the item-information table 25, the customer-information table 26, the fixed-period-sales-price table 27, the assessed-price table 28, and the cost table 29. The structure of each table is described below.

### 1.4.3.1. Item-Information Table 25

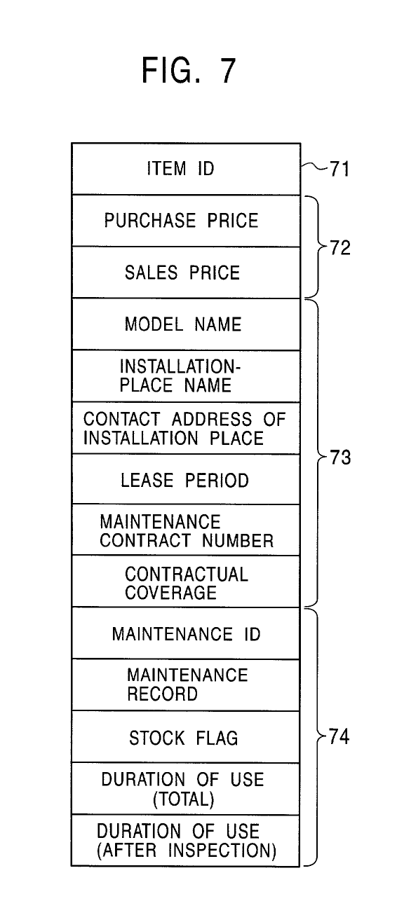

FIG. 7 shows the configuration of records constituting the item-information table 25. The item-information table 25 includes one record for each item. Each record has the contents shown in FIG. 7. The record contains an item ID 71 for uniquely specifying an item, data 72 (purchase price and sales price) that is generated by the fixed-period-sales-price generator 21, a group 73 of particulars related mainly to the details of the lease contract, and a group 74 of particulars. It is common for the group 73 to be sent from the leasing-company terminal 5 to the database unit 24, and it is common form the group 74 to be sent from the maintenance-company terminal 6 to the database unit 24. However, the groups 73 and 74 may be input from the related-company terminal. The item ID 71 and each of the other particulars are recorded on the item-information table 25 in one-to-one correspondence. Thus, by specifying the item ID 71, all the particulars of the item, such as the purchase price, lease period, and maintenance record of the item, can be arbitrarily extracted. Conversely, by setting conditions on particulars, and retrieving each item ID that satisfies the conditions, a list of items matching the conditions can be obtained.

### 1.4.3.2. Customer-Information Table 26

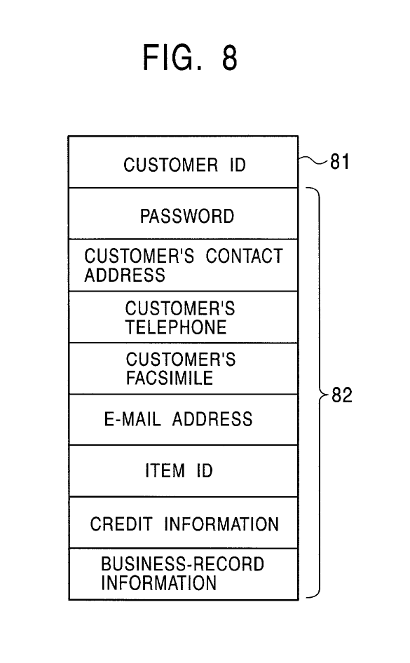

FIG. 8 shows the configuration of records constituting the customer-information table 26. The customer-information table 26 includes one record for each customer. Each record contains the contents shown in FIG. 8. The record contains a customer ID 81 for uniquely specifying a customer, and a group 82 of particulars mainly concerning the lease contract. Although it is common for the group 82 to be sent from the leasing-company terminal 5 to the database unit 24, the group 82 may be input from the related-company terminal. The customer ID 81 and each of the other particulars are recorded on the customer-information table 26 in one-to-one correspondence. Thus, by specifying the customer ID 82, all the particulars of the customer can be arbitrarily extracted. Conversely, by setting conditions on particulars, and retrieving each customer ID that satisfies the conditions, each customer matching the conditions can be selected.

### 1.4.3.3. Fixed-Period-Sales-Price Table 27

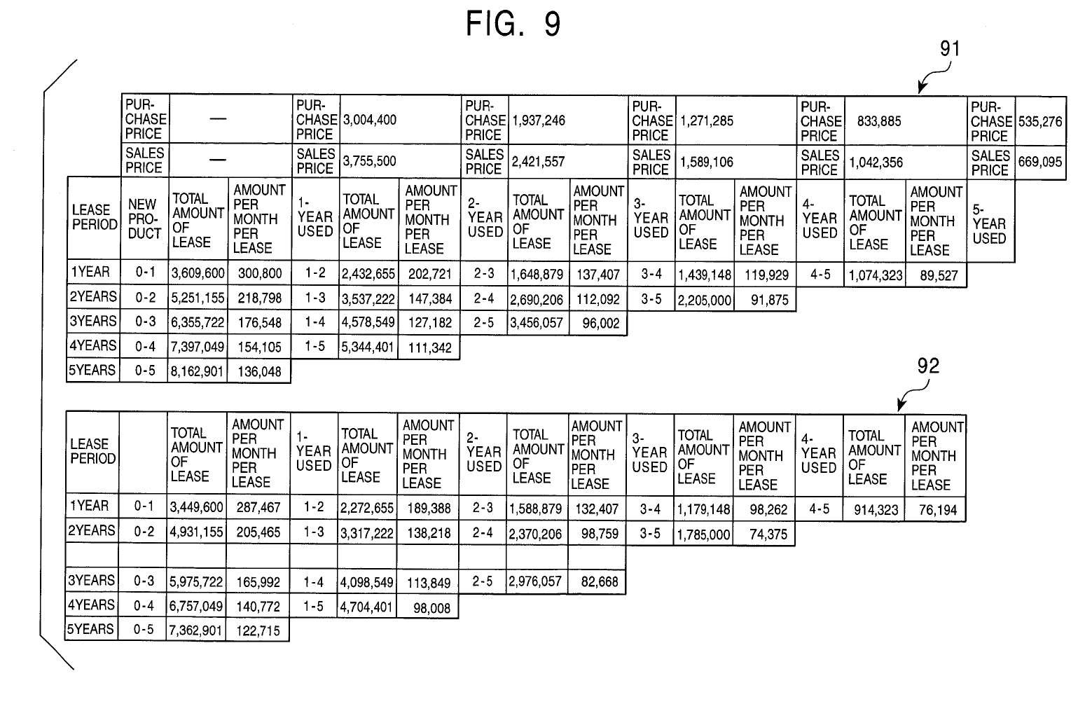

FIG. 9 shows the configuration of records constituting the fixed-period-sales-price table 27. The fixed-period-sales-price table 27 includes one record for each item. The record contains the contents shown in FIG. 9. In each record, the sales price f(X), the purchase price f′(X), and the fixed-period sales price F(X₁, X₂) which are generated by the fixed-period-sales-price generator 21 are recorded in a form correlated with the item ID. FIG. 9 shows cases obtained when X is 0 to 5. The area 91 shown in FIG. 9 shows values for Japanese domestic cases, and the area 92 shows values for cases in which overseas special contracts are made. The area 92 shows an example in which the amount of money changes due to a legal applicable range such as an allowable amount of money carried overseas. The fixed-period-sales-price table 27 is not limited to the configuration shown in FIG. 9.

### 1.4.3.4. Assessed-Price Table 28

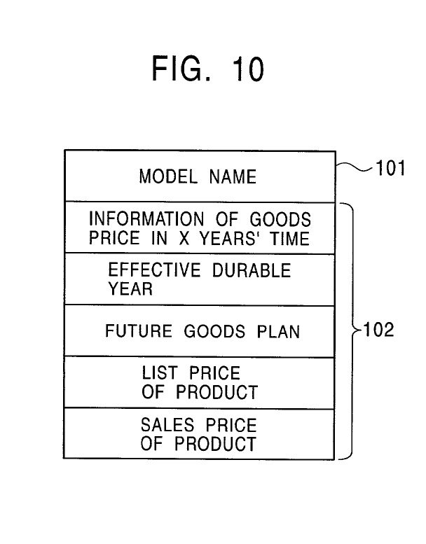

FIG. 10 shows the configuration of records constituting the assessed-price table 28. The assessed-price table 28 includes one record for each model name. Each record contains the contents shown in FIG. 10. The record contains a model name 101 and a group 102 of particulars mainly concerning information retained by the brand-new-sales company 3. Although it is common for the group 102 to be sent from the brand-new sales company 3 to the database unit 24, the group 102 may be input from the related-company terminal. The particulars of the group 102 are used for generating the fixed-period sales price F(X₁, X₂).

### 1.4.3.5. Cost Table 29

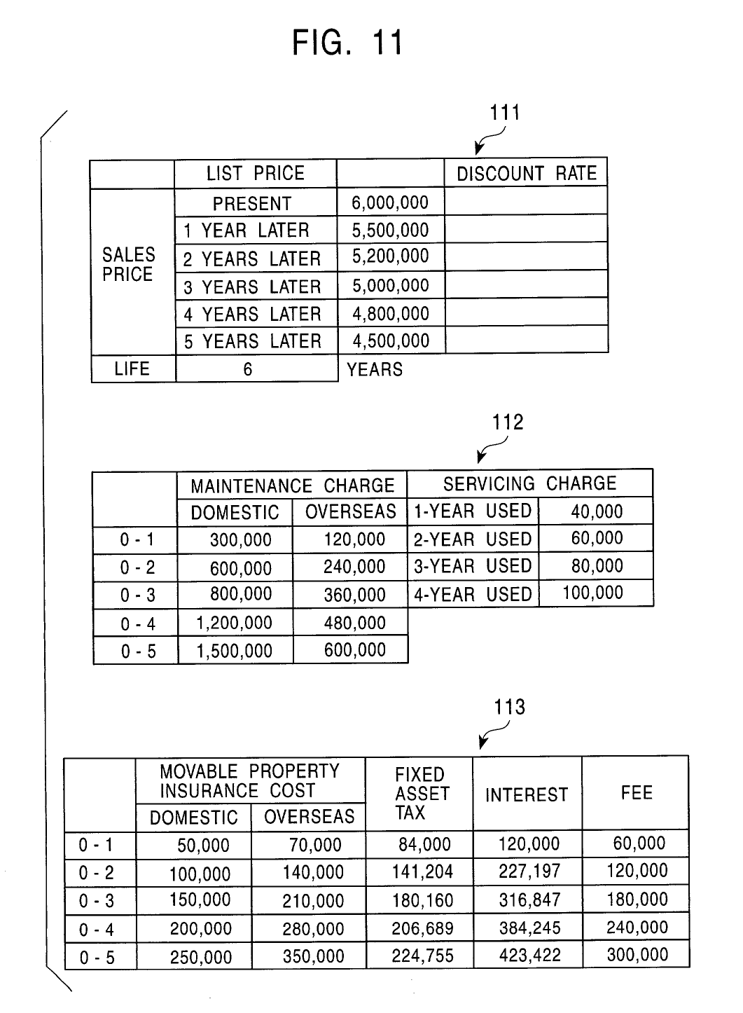

FIG. 11 shows the configuration of records constituting the cost table 29. The cost table 29 includes one record for each model name. Each record contains the contents shown in FIG. 11. The record contains a model name, an area 111 concerning sales prices which are mainly retained by the brand-new sales company 3, an area 112 concerning maintenance costs which are mainly retained by the maintenance company 6, and an area 113 concerning insurance costs, etc., which are mainly retained by the leasing company 5. It is common for data stored in the area 111 to be sent from the brand-new-sales-company terminal 3 to the database unit 24. It is common for data stored in the area 112 to be sent from the maintenance-company terminal 6 to the database unit 24. It is common for data stored in the area 113 to be sent from the leasing-company terminal 5 to the database unit 24. However, the data stored in the area 111, the data stored in the area 112, and the data stored in the area 113 may be input from the related-company terminal. These are mainly used for calculating the fixed-period-sales price, etc.

### 1.4.4. Example of Structure of Lease-Business-Information Provider 22

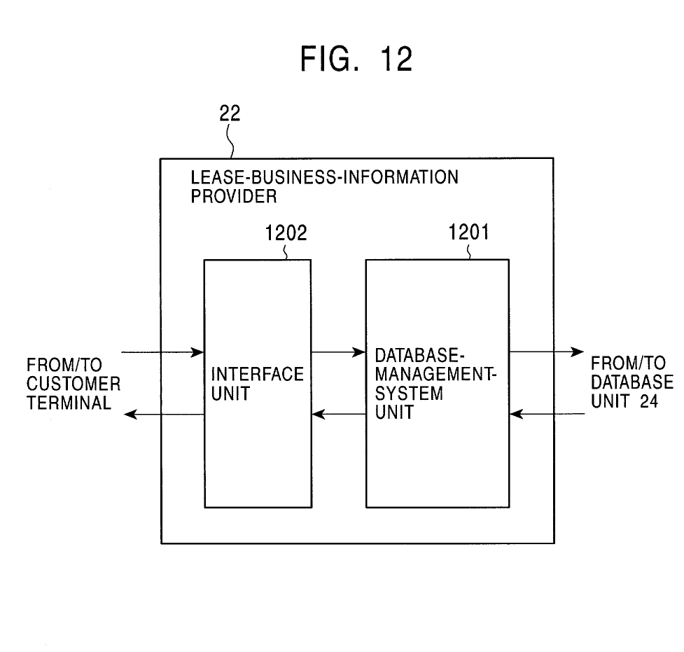

An example of the structure of the lease-business-information provider 22 is described below with reference to FIG. 12.

FIG. 12 is a block diagram showing an example of the lease-business-information provider 22. The lease-business-information provider 22 includes an interface unit 1202 connected to the customer terminal 2, and a database-management-system unit 1201 which is connected to the interface unit 1202 and which is connected to the database unit 24.

The database-management-system unit 1201 has functions of performing storage management, access control, query processing, and transaction processing on the database unit 24 in response to requests from the customer terminal 2.

The interface unit 1202 has functions of processing a request from the customer terminal 2 to generate a form processible for reception by the database-management-system unit 1201, and processing the data extracted from the database unit 24 to generate a form (e.g., HTML document) receivable by the customer terminal 2 before transmitting the processed data.

### 1.4.5. Example in Which Lease-Business Support Apparatus 1 Operates

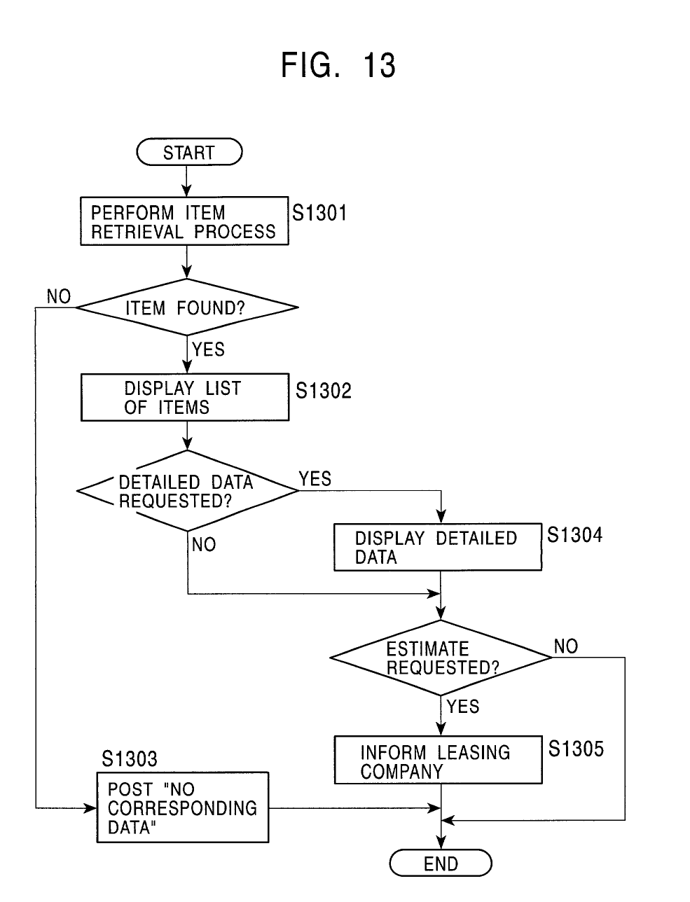

By exemplifying a case in which a customer uses the lease-business support apparatus 1 to retrieve an item, an example in which the lease-business support apparatus 1 operate is described below with reference to FIG. 13.

FIG. 13 is a flowchart showing a process performed by the lease-business support apparatus 1 when an item-retrieving request is sent from the customer terminal 2 to the lease-business support apparatus 1.

First, the customer terminal 2 sends an item-retrieving request to the lease-business support apparatus 1.

Regarding retrieval conditions, it is preferable that arbitrary retrieval conditions in accordance with customer's convenience be set, such as retrieval based on a model name and retrieval based on a price.

In step S1301, when the lease-business support apparatus 1 receives the request, each item that satisfies conditions included in the request is found and retrieved by the database unit 24 and the lease-business-information provider 22. For example, when a sales-price condition is specified, the item-information table 25 is searched, and the item ID of each record that has a sales price satisfying the condition is acquired.

If each record satisfying the condition is found by the retrieval, basic information (e.g., model names, duration of use) corresponding to the acquired item IDs are sent as an item list to the customer terminal 2 in step S1302. If no record is found, information representing “no corresponding data” is posted to the customer terminal 2 in step S1303, and the process is terminated.

The item list is displayed on the screen of the customer terminal 2. The item list is provided with a details-requesting function for requesting detailed information on each item. For example, a button object that sends a details-requesting message to the lease-business support apparatus 1 when the object is clicked on may be provided on the displayed item list. After a displayed item the detailed information of which is desired by the customer is designated with a pointing device, when the details-requesting function is used to send a details-display request, the item ID of the designated item and the details-display request are sent from the customer terminal 2 to the lease-business support apparatus 1. The lease-business support apparatus 1 sends back the detailed information (e.g., fixed-period-sales price, maintenance record, item-usable time, etc.) of the designated item, and the customer terminal 2 displays the detailed information in step S1304.

The detailed information displayed on the screen of the customer terminal 2 is provided with an estimate-requesting function for requesting estimate information on each item. For example, a button object that sends an estimate-requesting message to the lease-business support apparatus 1 when the object is clicked on may be provided on the displayed detailed information. After a displayed item the estimate information of which is desired by the customer is designated with the pointing device, the estimate-requesting function is used to send the item ID of the designated item and the estimate-requesting message to the lease-business support apparatus 1. It is preferable that the lease-business support apparatus 1 automatically notify the leasing company 5 of the reception of the estimate request in step S1305. The notification may be performed by an electronic mail generator (not shown) provided in the lease-business support apparatus 1 or by using a facsimile transmitter (not shown) provided in the lease-business support apparatus 1 to communicate with the leasing company 5.

According to this embodiment, the item list may include each so-called “possible item” which is currently leased to a certain customer but can be leased in future to another customer by the termination of the lease period. The inclusion can be performed such that each record in the item-information table 25 includes the lease period. By including the possible item in the item list, consecutive lease contracts; on a single item can be obtained, whereby the use of the remaining value of the item is maximized. This technique can suppress the fixed-period sales price because a period in which the item lies idle does not occur, and has a merit in that competitiveness against other lease business can be enhanced.

In addition, the lease-business support apparatus 1 according to the embodiment enables a first customer who uses a leased item to find a second customer who is likely to use the item on a lease after the period of the lease to the first customer terminates. For example, by using the item retrieving step (S1301 ), a second customer who uses an item having a model older that of an item that is being used by a first customer can be found. A service model can be provided in which, when the first customer informs the leasing company 1 of the second customer and a lease contract is made between both, the first customer can enjoy a price merit. This results in a merit in that attraction on customers can be enhanced.

### 1.5. Advantages of Embodiment

According to an advantage of this embodiment, regarding a product in which maintenance-record information retained by the maintenance company 6 can be managed during the life of the product, the maintenance-record information, and product information (a price, functions, specifications, etc.) and assessed-price information which are retained by the brand-new sales company 3 are shared on the database unit 24, whereby high-quality items can be inexpensively leased to customers by performing quality management and appropriate fixed-period-sale-price calculation for each item.

The embodiment also has the following advantage.

The leasing company 1, the brand-new sales company 3, and the secondhand-sales company 4 make business determination with appropriate timing because each of the companies can perform retrieval, estimation, and ordering without distinction of a new product and a secondhand product.

The leasing company 1 can set an appropriate remaining price and an appropriate lease price in systematic cooperation with the brand-new sales company 3 and the secondhand-sales company 4 by using the database unit 24, whereby the leasing company 1 is superior in competitiveness against another leasing company that does not have such a function. If the leasing company 1 does not have confidence in the precision of setting a remaining value, it must set a low remaining value, and the lease charge will accordingly increase.

The leasing company 1 can acquire the maintenance-record information as lease-business information. Thus, the leasing company 1 can obtain a high-quality secondhand product from the secondhand-sales company 4 and can obtain high royalties from customers.

### 2. Second Embodiment of the Present Invention

Next, a second embodiment of the present invention is described below.

In the second embodiment, customers are classified into a plurality of layers, and the lease-business support apparatus 1 provides lease-business information having contents according to each layer. For example, customers are classified into three classes: “Premium Customers”; “Semi-Premium Customers”, and “General Customers” in accordance with the business records and credit information of the customers. More advantageous information or service is provided to customers belonging to a higher class. One example is that each Premium Customer and each Semi-Premium Customer may recognize profiles of apparatuses and equipment on a Web site so as to use a quality-guaranteed apparatus and equipment on a lease without anxiety, while each General Customer may recognize only a sample of the profiles.

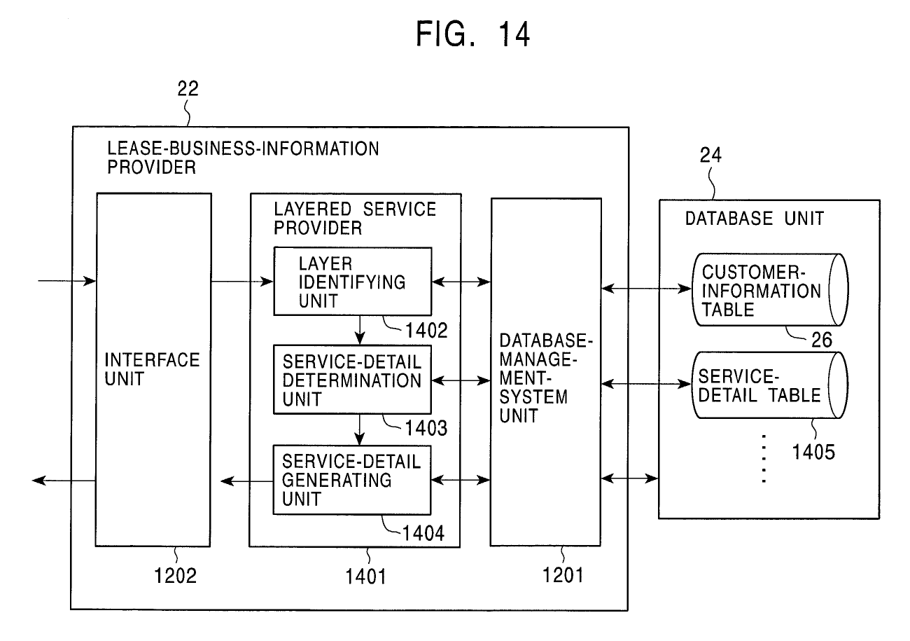

The lease-business support apparatus 1 according to the second embodiment is almost identical in structure to that shown in FIG. 2, but differs in that, as FIG. 14 shows, the lease-business-information provider 22 includes a layered service provider 1401 connected between the interface unit 1202 and the database-management-system unit 1201, the database unit 24 further includes a service-detail table 1405, and each record of the customer-information table 26 further includes a class code for specifying a layer to which each customer belongs.

The layered service provider 1401 has a function of providing lease-business information that differs for each class.

When receiving a customer ID sent from the customer terminal 2, the layered service provider 1401 searches the customer-information table 26 in the database unit 24, reads a class code included in a record corresponding to the customer ID, and sends the class code to a service-detail determination unit 1403.

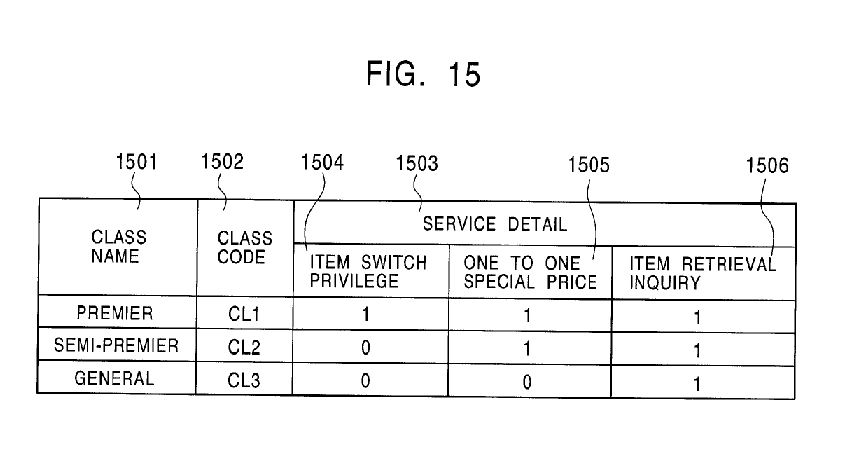

When receiving the class code, the service-detail determination unit 1403 searches the service-detail table 1405 of the database unit 24, and reads service details corresponding to the customer code. The structure of the service-detail table 1405 is shown in FIG. 15. In this example, the service-detail table 1405 contains a class name field 1501 containing class names, a class code field 1502 containing class codes, and a service detail field 1503. In this example, the service detail field 1503 consists of an “Item Switch Privilege” subfield 1504, a “One to One Special Price” subfield 1505, and an “Item Retrieval Inquiry” subfield 1506. The number of subfields is not limited to three but may be any number representing plurality. In each subfield, data which is correlated with each class code and which indicates whether service provision is possible or impossible (“1” or “0” in FIG. 15) is recorded. As FIG. 15 shows, each Premium Customer can receive all of the three services, namely, the “Item Switch Privilege”, “One to One Special Price”, and “Item Retrieval Inquiry” services. Each Semi-Premium Customer can only receive the two services, the “One to One Special Price”, and “Item Retrieval Inquiry” services. Each General Customer can only receive the “Item Retrieval Inquiry” service.

When the service-detail determination unit 1403 receives the class code, it searches the service-detail table 1405 of the database unit 24 and reads service details corresponding to the customer ID. After that, it notifies a service-detail generating unit 1404 of the service details as providable ones.

The service-detail generating unit 1404 responds to the customer terminal 2 by using the providable service details in a usable form. For example, when the result of retrieval based on a customer ID indicates that the customer belongs to the General Customer class, the service-detail generating unit 1404 sends, to the customer terminal 2, a Web page by which the “Item Retrieval Inquiry” service may be used. In addition, when the result of retrieval based on a customer ID indicates that the customer belongs to the Premier Customer class, the service-detail generating unit 1404 sends, to the customer terminal 2, a Web page by which all of the three services, the “Item Switch Privilege”, “One to One Special Price”, and “Item Retrieval Inquiry” services may be used.

In the above structure, the lease-business support apparatus 1 according to the second embodiment can provide different lease-business information depending on each customer class.

According to the second embodiment, customers will continue to maintain stable lease business without delay of payment in order to receive better lease-business information. This makes it possible to maintain business connections with good customers for a long period.

### 3. Other Embodiments

The following constructions are possible as other embodiments of the present invention.

A Web side that is linked to the lease-business support apparatus 1 is provided. One embodiment of the present invention is designed so that, by accessing the Web site, a customer can perform retrieval, query, estimation, and ordering on an item on line.

The lease-business support apparatus 1 may include an electronic settlement unit so that a customer can make use of electronic settlement on small-amount business.

Moreover, by affixing an integrated circuit seal to each item to be leased so that the item has item-identification information and can be linked to information such as lease-record information, asset-management information, maintenance information, and customer information, secure and efficient management can be performed.

What is claimed is:

1. A lease-business support apparatus comprising
means in which lease-business-information-generating data is stored, wherein the lease-business-information-generating data is used to generate the fixed-period sales price of an item, and lease-business information including the fixed-period. sales price is provided to at least one customer terminal connected to said lease-business support apparatus in response to a request from said at least one customer terminal.

2. A lease-business support apparatus according to claim 1, further comprising a fixed-period-sales-price generator for generating the fixed-period-sales price, said fixed-period-sales-price generator comprising:
a sales-price/purchase-price-data generator which generates the sales price and purchase price of the item by using an estimated sales price, a depreciation factor, legal durable years, and effective durable years which are included in the lease-business-information-generating data; and
a fixed-period-sales-price calculator which receives and uses the sales price and the purchase price to generate the fixed-period-sales price.

3. A lease-business support apparatus according to claim 2, wherein:
said fixed-period-sales-price generator includes a price-adequacy checker which receives the fixed-period sales price from said fixed-period-sales-price calculator; and
said price-adequacy checker calculates both a first gross profit obtained when simply selling an item and a second gross profit obtained by the fixed-period sale of said item, and verifies whether or not said second gross profit is greater than said first gross profit;
said price-adequacy checker calculates both the sum of a profit obtained by the fixed-period sale of identical models of said item and a profit obtained by the number of sales increased by the fixed-period sale, and the discarding cost required for discarding models among said identical models, and verifies whether or not the calculated sum is greater than said discarding cost; and
said price-adequacy checker confirms price adequacy when said second gross profit is greater than said first gross profit and the calculated sum is greater than said discarding cost,

4. A lease-business support apparatus according to claim 1, further comprising an item-information table containing lease periods as particulars which are correlated with the pieces of item-identification information,
wherein said lease-business support apparatus provides said at least one customer terminal with lease-business information including a list of possible items to be leased.

5. A lease-business support apparatus according to claim 1, further comprising an item-information table containing lease periods as particulars which are correlated with the pieces of item-identification information,
wherein, by using said lease periods, said lease-business support apparatus provides said at least one customer terminal with information on each customer who is expected to desire a lease contract for an item after the lease period of said item terminates.

6. A lease-business support apparatus according to claim 1, wherein the customers are classified into a plurality of classes based on at least one of business-record information and credit information corresponding to each of the customers, and a different type of lease-business information is provided to each of the customer terminals corresponding to each of the customers in accordance with each of the classes to which the customer belongs.

7. A lease-business support apparatus according to claim 6, further comprising:
a layer identifying unit which acquires the class code corresponding to a customer ID sent from the customer terminal;
a service-detail determination unit which receives the sent class code and acquires the service detail corresponding to said class code; and
a service-detail generating unit which generates and provides, to the customer terminal, lease-business information based on the acquired service detail.

8. A lease-business support method for providing at least one customer terminal with lease-business information including the fixed-period sale of an item in response to a request from said at least one customer terminal, said lease-business support method comprising the steps of:
generating the sales price and purchase price of the item by using an estimated sales price, a depreciation factor, legal durable years, and effective durable years; and
generating the fixed-period-sales price of the item by receiving and using said generated sales price and purchase price.

9. A lease-business support method according to claim 8, further comprising the steps of:
calculating both a first gross profit obtained when simply selling said item and a second gross profit obtained by the fixed-period sale of said item and verifying whether or not said second gross profit is greater than said first gross profit;
calculating both a profit obtained by the fixed-period sale of identical models of said item and the discarding cost required for discarding models among said identical models and verifying whether or not said profit is greater than the calculated discarding cost; and
confirming price adequacy when said second gross profit is greater than said first gross profit and said profit is greater than the calculated discarding cost.

10. A computer-readable recording medium containing a program for operating a lease-business support apparatus as set forth in claim 1.

11. A computer-readable recording medium containing a program for operating a lease-business support apparatus as set forth in claim 2.

12. A computer-readable recording medium containing a program for operating a lease-business support apparatus as set forth in claim 3.

13. A computer-readable recording medium containing a program for operating a lease-business support apparatus as set forth in claim 4.

14. A computer-readable recording medium containing a program for operating a lease-business support apparatus as set forth in claim 5.

15. A computer-readable recording medium containing a program for operating a lease-business support apparatus as set forth in claim 6.

16. A computer-readable recording medium containing a program for operating a lease-business support apparatus as set forth in claim 7.
